(19) United States
(12) Patent Application Publication
(10) Pub. No.: US 2006/0016913 A1
(43) Pub. Date: Jan. 26, 2006

(54) Watering device with long shank

(76) Inventor: Sun-Nan Lo, ChangHua City (TW)

Correspondence Address: WANG KING -YUAN, P.O. Box 487, Changhua City 500, R.O.C., TW

(21) Appl. No.: 10/915,482

(22) Filed: Aug. 11, 2004

(30) Foreign Application Priority Data
Jul. 23, 2004 (TW) 093211739

(51) Int. Cl. B05B 7/02; B05B 15/06; B05B 9/01

(52) U.S. Cl. 239/532; 239/531; 239/525

(57) ABSTRACT

A watering device includes a head, an adjusting set and a hollow shank connected between the head and the adjusting set which is connected to the water source. The adjusting set includes an operation member having a through hole defined in a close end thereof and a board having a plurality of holes is connected to the close end of the operation member so that water may enter the shank and the head via the aligned through hole of the operation member and one of the holes in the board. By choosing the size of the hole in the board and pattern hole in the head, desired pattern of water stream is obtained from the head.

### FIELD OF THE INVENTION

The present invention relates to a watering device having a long shank and two sets of dispensing members are respectively connected to two ends of the long shank so as to guide water to the sprinkler head.

### BACKGROUND OF THE INVENTION

A conventional watering device is disclosed in FIG. 8 and generally includes a head 7 with a long shank 8 connected thereto. The handle 10 has a first end connected to the shank 8 and a second end of the handle 10 is connected to a hose through which water is supplied to the shank 8. A dispensing member 9 is connected to the first end of the handle 10 and a plurality of small hoses 6 are combined and connected to the dispensing member 9. The small hoses 6 are inserted in the shank 8 and extend through the head 7. Another dispensing member 5 is connected to the head 7 and includes three pattern holes which are in communication with the small hoses 6. It is noted that the small hoses 6 have to be adhered with each other so as to be secured in the shank 8. Due to the thickness of walls of the small tubes 6, only limited number of the small tubes 6 can be inserted in the shank 8 and the thickness of the small hoses 6 limits the volume of water going through the shank 8. It takes a lot of time to install the small hoses 6 in the shank 8 and the diameter of the small hoses 6 could be narrowed by the adhesive used for connecting the small hoses 6.

The present invention intends to provide a watering device wherein no small hoses are needed and the watering device can be assembled within a short period of time.

### SUMMARY OF THE INVENTION

The present invention relates to a watering device that comprises a head connected to a first end of a hollow shank which has a plurality of first ribs extending radially from an elongate core and connected to an inner periphery of the shank. An adjusting set is connected to a second end of the shank and includes an operation member. A through hole is defined in a close end of the operation member and an end member is connected to the other end of the operation member. The end member has a tube which has an opening defined through a wall thereof. A board is biased by the tube and includes a plurality of holes and one of the holes is in alignment with the through hole of the operation member. A dispensing member has a peripheral wall extending from a first side thereof and the peripheral wall is connected to the board opposite to the tube and a gap is defined between the board and the dispensing member. A plurality of tubes extend from a second side of the dispensing member and communicate with the gap between the board and the dispensing member. The tubes are engaged with the first ribs in the shank, a locking collar mounted to the second end of the shank and threadedly connected to the operation member.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show the watering device of the present invention;

FIG. 2 is a plane view of the watering device of the present invention;

FIG. 3 is an exploded view of the adjusting set of the watering device of the present invention;

FIG. 4 is an exploded view, from another angle of view, of the adjusting set of the watering device of the present invention;

FIG. 5 is an exploded view of the head of the watering device of the present invention;

FIG. 6 is an exploded view, from another angle of view, of the head of the watering device of the present invention;

FIG. 7 is a cross sectional view of the adjusting set of the watering device of the present invention, and

FIG. 8 is an exploded view of a conventional watering device.

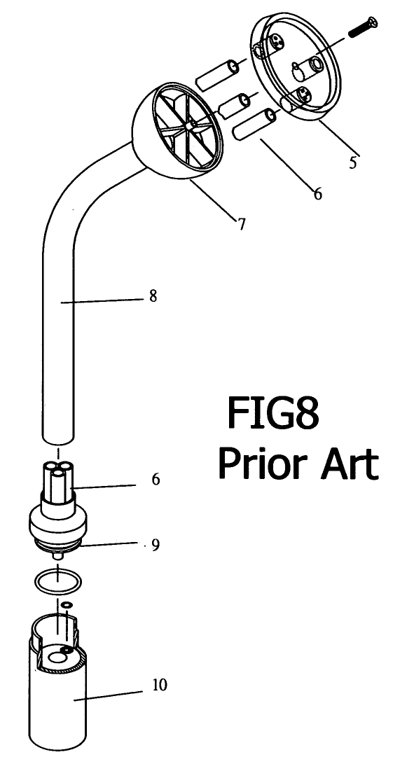

### DETAILED DESCRIPTION OF THE PREFERRED EMBODIMENT

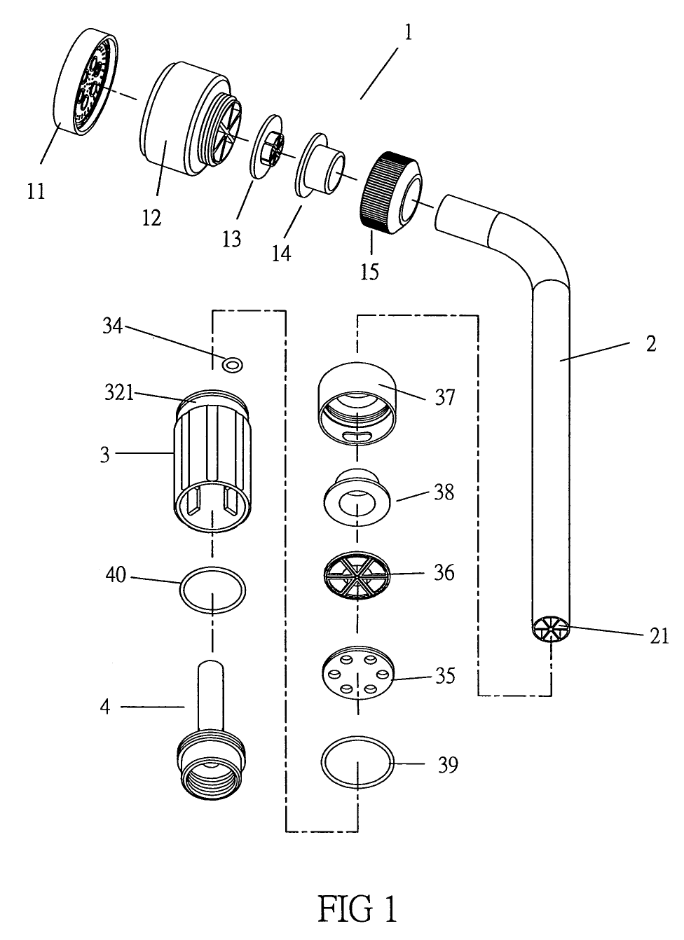

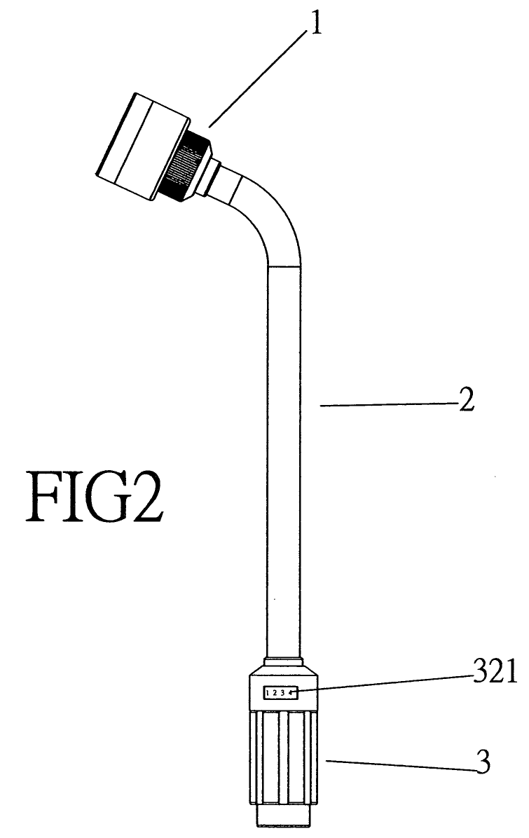

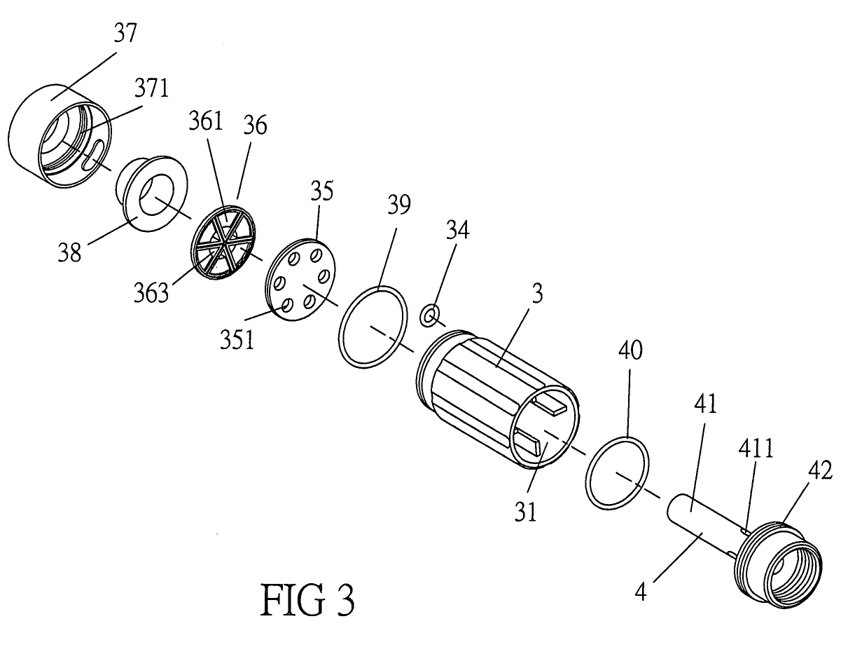

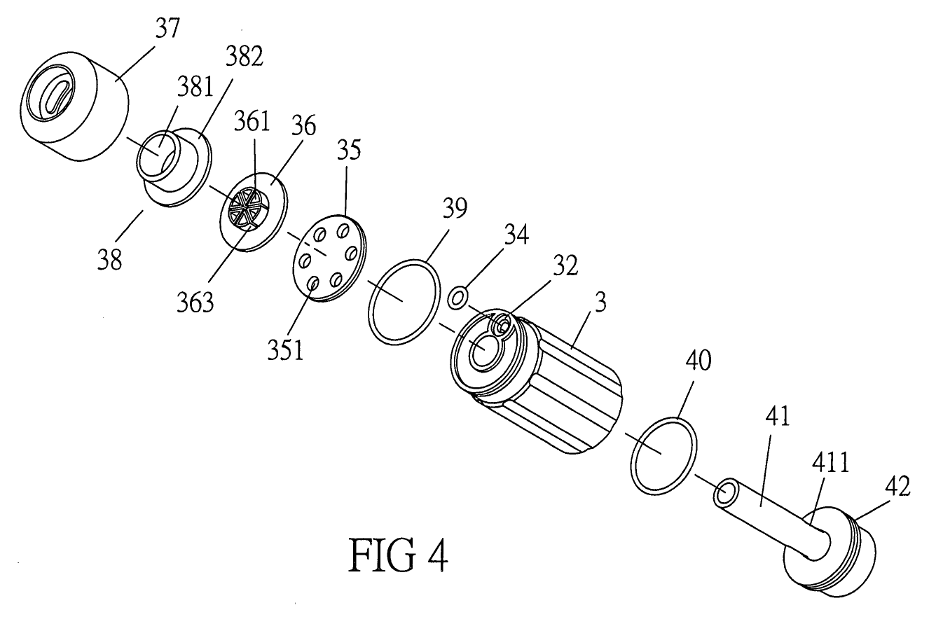

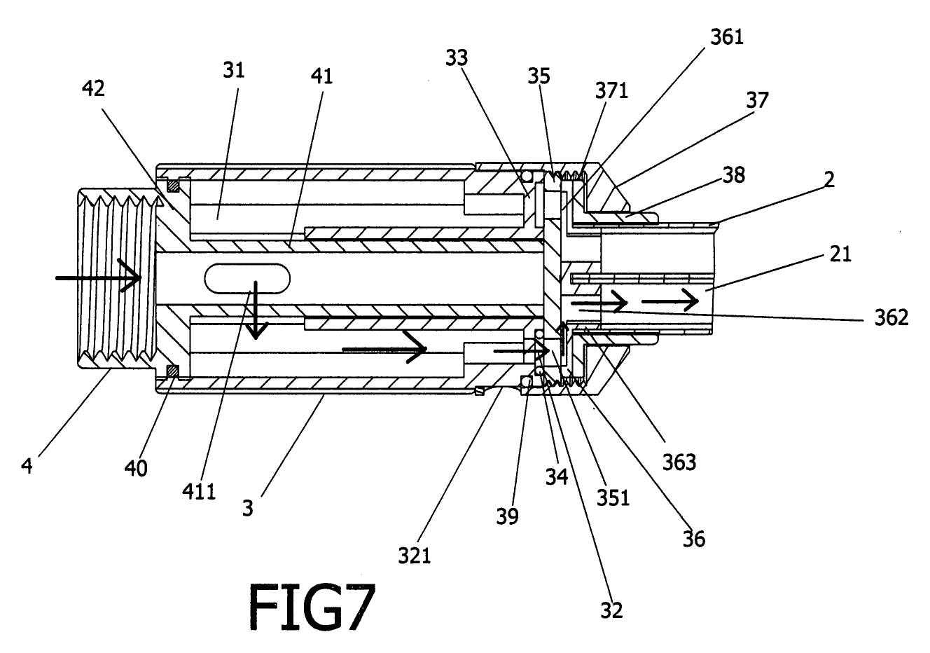

Referring to FIGS. 1 to 4 and 7, the watering device of the present invention comprises a head 1 connected to a first end of a hollow shank 2 and an adjusting set is connected to a second end of the shank 2. A water supply is connected to the adjusting set. The shank 2 has a plurality of first ribs 21 extending radially from an elongate core and connected to an inner periphery of the shank 2.

The adjusting set includes an operation member 3 having a through hole 32 defined in a close end 33 thereof and an end member 4 is connected to the other end of the operation member 3 with a seal 40 sealing the operation member 3. The end member 4 has a tube 41 which has an opening 411 defined through a wall thereof and is inserted in the interior space 31 of the operation member 3. A board 35 is biased by the tube 41 and includes a plurality of holes 351 which may have different sizes, and one of the holes 351 is in alignment with the through hole 32 of the operation member 3. A seal 34 is engaged with a sink recess enclosing the through hole 32 to prevent from leakage. A dispensing member 36 has a peripheral wall extending from a first side thereof and the peripheral wall is connected to the board 35 opposite to the side contacting the tube 41, and a gap 361 is defined between the board 35 and the dispensing member 36. A plurality of tubes 133 extend from a second side of the dispensing member 36 and communicate with the gap 361 between the board 35 and the dispensing member 36. The tubes 133 are engaged with the first ribs 21 in the shank 2. A locking collar 37 is mounted to the second end of the shank 2 with a seal 39 engaged therebetween and threadedly connected to a threaded portion 42 on the operation member 3. A receiving member 38 has a tubular section 381 and a flange 382 extends radially from the tubular section 381. The tubular section 381 extends through the locking collar 37 and the second end of the shank 2 inserted in the tubular section 381. An inside of the locking collar 37 contacts the flange 382. Water enters the interior space 31 of the operation member 3 via the opening 411 and flows through the hole 351 and enters the gap 361. The water then enters the shank 2 via the through holes 362 of the dispensing member 36. By rotating the operation member 3 and checking the index 321 marked thereon via a window defined in the locking collar 37 may adjust the desired the hole 351 in the board 35 to be in alignment with the through hole 32 of the operation member 3, such that the water can be used in a desired way.

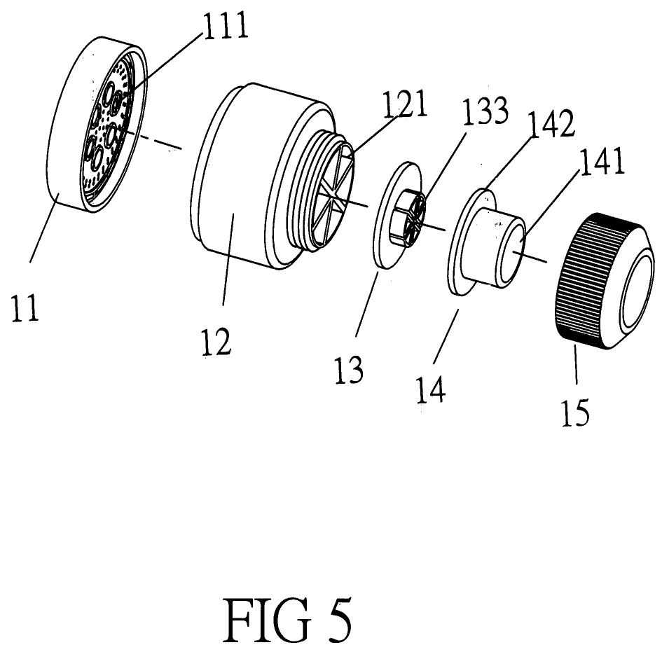

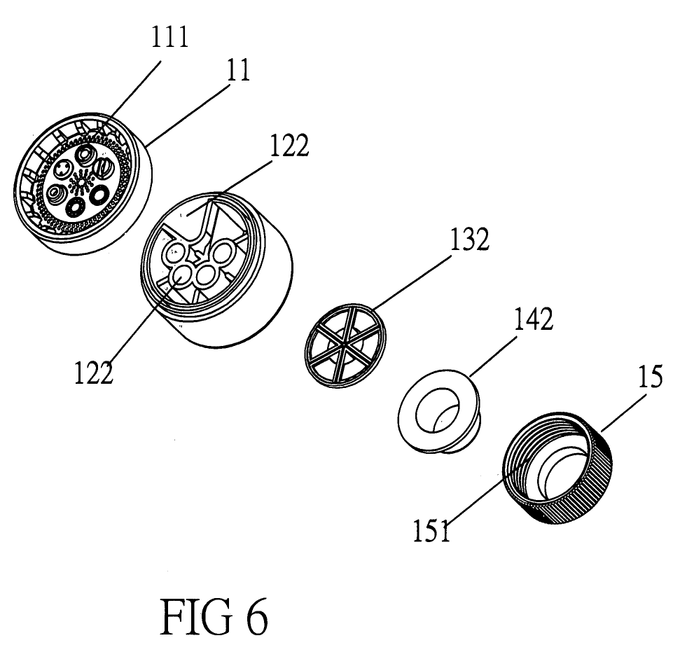

Referring to FIGS. 5 and 6, the head 1 includes a connection member 13 having a hole defined centrally therethrough and a plurality of tubes 133 extend from a first side thereof. Gaps are defined between the tubes 133 which are in communication with the hole in the connection member 13. The first ribs 21 in the shank 2 are engaged with the gaps between the tubes 133. A plurality of second ribs 132 extend from a second side of the connection member 13. A guide member 12 has a plurality of stream paths 122 defined therein and a threaded neck extends from an end of the guide member 12. The threaded neck includes a plurality of chambers 121 separated by ribs 121 received therein and the second ribs 132 of the connection member 13 are engaged with the chambers 121. A pattern member 11 is connected to an end opposite to the end having the threaded neck and has a plurality of pattern holes 111 which are in communication with the stream paths 122 in the guide member 12. A locking collar 15 has threaded inner periphery 151 and is mounted to the first end of the shank 2. The threaded inner periphery 151 is connected to the threaded neck of the guide member 12. A receiving member 14 has a tubular section 141 and a flange 142 extends radially from the tubular section 141. The first end of the shank 2 inserted in the tubular section 141 which extends through the locking collar 15 and an inside of the locking collar 15 contacts the flange 142.

While we have shown and described the embodiment in accordance with the present invention, it should be clear to those skilled in the art that further embodiments may be made without departing from the scope of the present invention.

What is claimed is:

1. A watering device comprising:
a head (1) and a hollow shank (2) having a first end thereof connected to the head (1), the shank (2) having a plurality of first ribs (21) extending radially from an elongate core and connected to an inner periphery of the shank (2), and
an adjusting set connected to a second end of the shank (2) and including an operation member (3) having a through hole (32) defined in a close end (33) thereof and an end member (4) connected to the other end of the operation member (3), the end member (4) having a tube (41) which has an opening (411) defined through a wall thereof, a board (35) biased by the tube (41) and including a plurality of holes (351) and one of the holes (351) being in alignment with the through hole (32) of the operation member (3), a dispensing member (36) having a peripheral wall extending from a first side thereof and the peripheral wall connected to the board (35) opposite to a side contacting the tube (41) and a gap defined between the board (35) and the dispensing member (36), a plurality of tubes (133) extending from a second side of the dispensing member (36) and communicating with the gap between the board (35) and the dispensing member (36), the tubes (133) engaged with the first ribs (21) in the shank (2), a locking collar (37) mounted to the second end of the shank (2) and threadedly connected to the operation member (3).

2. The watering device as claimed in claim 1, wherein the head (1) includes a connection member (13) having a hole defined centrally therethrough, a plurality of tubes (133) extending from a first side thereof and gaps defined between the tubes (133), the tubes (133) being in communication with the hole in the connection member (13), the first ribs (21) in the shank (2) engaged with the gaps between the tubes (133), a plurality of second ribs (132) extending from a second side of the connection member (13), a guide member (12) having a plurality of stream paths (122) defined therein and a threaded neck extending from an end of the guide member (12), the threaded neck including a plurality of chambers (121) separated by ribs (121) received therein and the second ribs (132) of the connection member (13) engaged with the chambers (121), a pattern member (11) connected to an end opposite to the end having the threaded neck and having a plurality of pattern holes (111) which are in communication with the stream paths (122) in the guide member (12), a locking collar (15) having threaded inner periphery (151) and mounted to the first end of the shank (2), the threaded inner periphery (151) connected to the threaded neck of the guide member (12).

3. The watering device as claimed in claim 1 further comprising a receiving member (38) having a tubular section (381) and a flange (382) extending radially from the tubular section (381), the second end of the shank (2) inserted in the tubular section (381) and an inside of the locking collar (37) contacting the flange (382).

4. The watering device as claimed in claim 2 further comprising a receiving member (14) having a tubular section (141) and a flange (142) extending radially from the tubular section (141), the first end of the shank (2) inserted in the tubular section (141) and an inside of the locking collar (15) contacting the flange (142).
